(19) United States
(12) Patent Application Publication
(10) Pub. No.: US 2003/0145051 A1
(43) Pub. Date: Jul. 31, 2003

(54) Method and system for selecting multiple sets of data in an application

(75) Inventors: Cary Lee Bates, Rochester, MN (US); Gilford Francis Martino, Endwell, NY (US); John Matthew Santosuosso, Rochester, MN (US); Vincent T. Timon III, Binghamton, NY (US)

Correspondence Address: HOFFMAN WARNICK & D'ALESSANDRO, LLC, 3 E-COMM SQUARE, ALBANY, NY, 12207

(73) Assignee: INTERNATIONAL BUSINESS MACHINES CORPORATION, Armonk, NY

(21) Appl. No.: 10/062,102

(22) Filed: Jan. 31, 2002

(51) Int. Cl. G06F 15/16

(52) U.S. Cl. 709/204

(57) ABSTRACT

A method and system for selecting multiple sets of data in an application is provided. Specifically, under the present invention, a first set of data is selected. Then, a predetermined keystroke is performed. After the keystroke is performed, a second set of data can be selected while the first set of data remains selected. The present invention also allows for multiple portions of a selected set of data to be selected. Specifically, the user can select a first portion of a selected set of data, perform another keystroke, and then select a second portion of the set while both the first portion and the set remain selected.

### BACKGROUND OF THE INVENTION

1. Field of the Invention

The present invention relates to a method and system for selecting multiple sets of data in an application. In particular, the present invention allows a set of data to be selected while another set of data is already selected.

2. Background Art

As the use of computer software becomes more prevalent, programmers are increasingly seeking more efficient ways to write code. Currently, many programmers write computer code using text editors, spreadsheet programs, web documents, or some other application capable of keyboard-based input. In writing new code, programers often utilize sections of code from an existing program. For example, if a programmer is writing a new version of an existing program, the programmer might wish to copy one or more sections of code from an old version. This prevents the programmer from having to manually re-enter the same code.

Currently, copying and pasting of data is typically accomplished by selecting/highlighting a desired set of data with a mouse or other input device, and then using the copy and paste features of the particular application. Problems arise, however, when multiple sets of data are desired to be copied. Current technology allows only one set of data to be selected at a time. Specifically, if a programmer selects a first set of data, the programmer cannot then select a second set of data without de-selecting the first set of data. Thus, if a programmer wishes to copy three sets of data from an existing program, the programmer must select, copy (i.e., to the clipboard), and then paste each set of data individually. This issue generally arises where the sets of data are non-contiguous. That is, when the sets of data are separated from each other by undesired data. Since the desired sets of data cannot be selected as a single unit, the programmer must select, copy, and paste the first set of data before attempting to select the second set of data. This requirement greatly reduces the efficiency of the programmer.

In addition, since current technology allows only a single set of data to be selected, a programmer cannot select portions of data within a selected set of data. For example, if a programmer selects a set of data having four lines of text, the programmer cannot then select a single word within the four selected lines (referred to herein as second level selection). Such a capability would provide the programmer with greater flexibility in manipulating the selected portions.

Heretofore, attempts have been made to alleviate these problems by providing improved clipboards. One such attempt allows a clipboard to contain multiple partitions of information. However, in copying information to the clipboard, each desired piece of information must still be individually selected and copied. No previous attempt improves efficiency by allowing a set of data to be selected while another is already selected.

In view of the foregoing, a need exists for a method and system for selecting multiple sets of data in an application. A further need exists for a method and system that allows a set of data to be selected while another is already selected so that the sets can be cut/copied and pasted as a single unit. Another need exists for a method and system that allows portions of a selected set of data to be selected for manipulation.

### SUMMARY OF THE INVENTION

The present invention overcomes the drawbacks of existing systems by providing a method and system for selecting multiple sets of data in an application. Specifically, under the present invention, a programmer can select a first set of data and then perform a predetermined keystroke. The keystroke allows the programmer to then select a second set of data without de-selecting the first set of data. In addition, the present invention further allows a programmer to perform second level selections. Such selection allows a programmer to select multiple portions of a selected set by performing a similar keystroke operation.

According to a first aspect of the present invention, a method for selecting multiple sets of data in an application is provided. The method comprises the steps of: (1) selecting a first set of data within the application; and (2) selecting a second set of data within the application, wherein the first set of data remains selected during the selection of the second set of data.

According to a second aspect of the present invention, a method for selecting multiple sets of data in an application is provided. The method comprises the steps of: (1) providing an application for manipulating data; (2) selecting a first set of data within the application; (3) performing a first predetermined keystroke; and (4) selecting a second set of data within the application, wherein the first set of data remains selected during the selection of the second set of data based upon the keystroke

According to a third aspect of the present invention, a method for selecting multiple sets of data in an application is provided. The method comprises the steps of: (1) providing an application for writing computer code; (2) selecting a first set of data within the application; (3) performing a predetermined keystroke; (4) selecting a second set of data within the application after selecting the keystroke, wherein the first set of data remains selected during the selection of the second set of data based upon the keystroke; (5) selecting a portion of one of the selected sets of data; (6) pasting the selected sets of data to a predetermined area; and (7) manipulating the selected portion after the pasting step.

According to a fourth aspect of the present invention, a program product stored on a recordable medium for selecting multiple sets of data in an application is provided. When executed, the program product comprises: (1) program code configured to select a first set of data and a second set of data within the application, wherein the first set of data remains selected during the selection of the second set of data based upon a predetermined keystroke; and (2) program code configured to select a portion of one of the selected sets of data.

According to a fifth aspect of the present invention, a system for selecting multiple sets of data in an application is provided. The system comprises: (1) a set selection system for selecting a first set of data and a second set of data within the application, wherein the first set of data remains selected during the selection of the second set of data based upon a predetermined keystroke; and (2) a portion selection system for selecting a portion of one of the selected sets of data.

Therefore, the present invention provides a method and system for selecting multiple sets of data in an application.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a box diagram of a computer system having a data system in accordance with the present invention.

FIG. 2 depicts two selected sets of data in accordance with the present invention.

FIG. 3 depicts the two selected sets of FIG. 2 pasted to a new area.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method and system for selecting multiple sets of data in an application. Specifically, the present invention allows a user to select a first set of data, and then select a second set of data while the first set remains selected. This capability is provided by performing a keystroke after selecting the first set of data. In previous systems, if a user attempted to select a second set of data, the first set would be automatically de-selected. The present invention also allows a user to select portions of a selected set of data using a similar technique. Specifically, once a set of data has been selected, a user could select a portion (e.g., a word) of the set, without de-selecting either the set or previously selected portions. As used herein, the term “selecting” refers to highlighting using a mouse or the like. This technique is well known in the art. In addition, performing a “keystroke” is intended to mean any use of a computer input/output (I/O) device such as pressing one or more keys on a computer keyboard, manipulating a computer mouse (e.g., pointing and/or clicking buttons), or any combination thereof.

It should be understood that although the present invention will be described in the context of a new computer program, it could be applied to any type of work in which data can be copied/cut from one area and pasted to another area. For example, the present invention could be used to create/modify a literary work. Moreover, it should be appreciated that the present invention is not limited to text-type data. For example, the present invention could be used to create/modify a graphical drawing, a video image, etc.

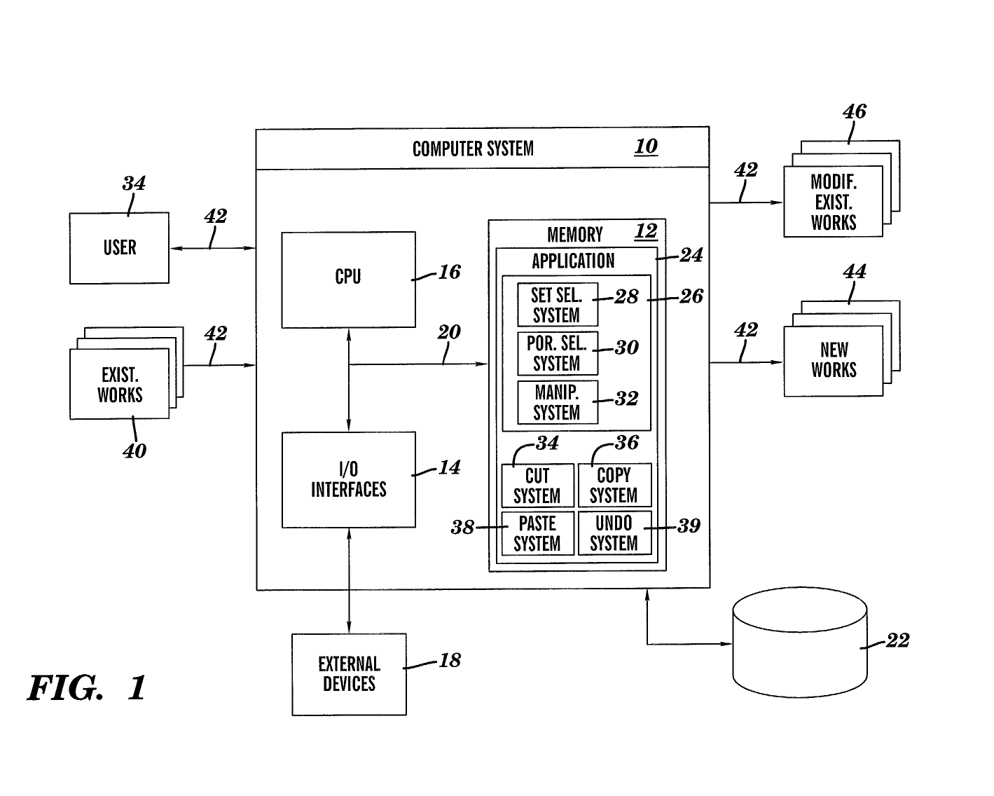

Referring now to FIG. 1, a computer system 10 implementation of the present invention is shown. Computer system 10 generally comprises memory 12, input/output (I/O) interfaces 14, a central processing unit (CPU) 16, external devices/resources 18, bus 20, and database 22. Memory 12 may comprise any known type of data storage and/or transmission media, including magnetic media, optical media, random access memory (RAM), read-only memory (ROM), a data cache, a data object, etc. Moreover, memory 12 may reside at a single physical location, comprising one or more types of data storage, or be distributed across a plurality of physical systems in various forms. CPU 16 may likewise comprise a single processing unit, or be distributed across one or more processing units in one or more locations, e.g., on a client and server.

I/O interfaces 14 may comprise any system for exchanging information from an external source. External devices 18 may comprise any known type of external device, including a CRT, LED screen, hand-held device, keyboard, mouse, voice recognition system, speech output system, printer, facsimile, pager, personal digital assistant, cellular phone, web phone, etc. Bus 20 provides a communication link between each of the components in the computer system 10 and likewise may comprise any known type of transmission link, including electrical, optical, wireless, etc. In addition, although not shown, additional components, such as cache memory, communication systems, system software, etc., may be incorporated into computer system 10.

Database 22 could provide storage for information necessary to carry out the present invention. Such information could include, inter alia: (1) existing works 40; (2) new works 44; and (3) modified existing works 46. Database 22 may include one or more storage devices, such as a magnetic disk drive or an optical disk drive. In another preferred embodiment database 22 includes data distributed across, for example, a local area network (LAN), wide area network (WAN) or a storage area network (SAN) (not shown). Database 22 may also be configured in such a way that one of ordinary skill in the art may interpret it to include one or more storage devices.

Stored in memory 12 is application 24. Application can be any software program or the like for manipulating data. For example, application 24 can be any program for writing computer code (e.g., a text editor such as MS Word, a spreadsheet such as MS Excel, a web document in MS Explorer, etc.). Under the present invention, application 24 includes data system 26 that allows for, among other things, multiple sets of data to be selected. As indicated above, a user 34 creating a new work 44 (e.g., a new computer program), may wish to copy multiple sets of data (i.e., sections) from an existing work 40 (e.g., existing computer program). Alternatively, user 34 may wish to copy sets of data from one area of an existing work 40 to another area of the same work to yield a modified existing work 46. Previously, user 34 was forced to select, copy, and then paste each desired set individually. Data system 26 allows user 34 to select a set of data without de-selecting a previously selected set. As shown, data system 26 includes set selection system 28, portion selection system 30, and manipulation system 32, which will be further described below. Application 26 can also include cut system 34, copy system 36, paste system 38 and undo system 39.

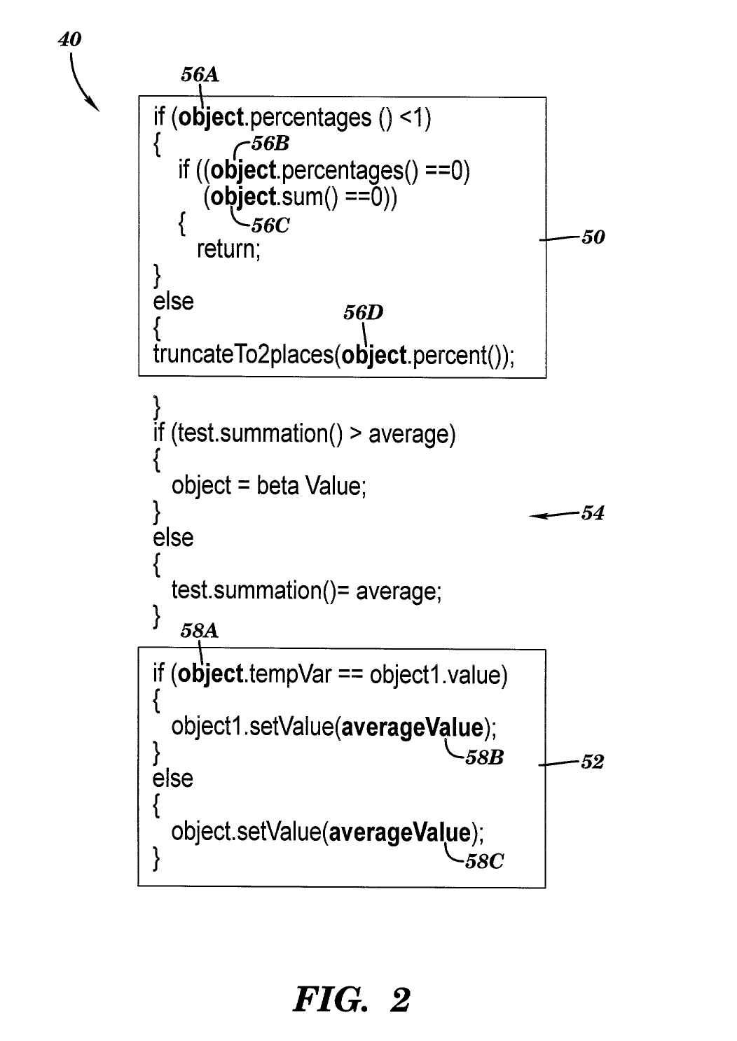

Referring now to FIG. 2, an exemplary existing work 40 is shown. Existing work 40 is shown as a computer program. However, as indicated above, existing work 40 can be many alternatives. When creating a new work or adding to existing work 40, a user may wish to copy sets of data 50 and 52. This would prevent the user from having to manually re-enter the data in sets 50 and 52. To copy sets 50 and 52 under previous systems, the user would have to select set 50, copy set 50 to the clipboard, and then paste set 50 to the new area before attempting to select set 52. FIG. 2 demonstrates that, under the present invention, both sets 50 and 52 can remain selected at the same time.

This functionality is provided by set selection system 28 of FIG. 1. Specifically, to select sets 50 and 52, the user will first select set 50. Selection of a set can occur through any known means in the art. For example, selection can occur by using the left mouse button to highlight the desired selection. Once set 50 has been selected, the user will perform a predetermined keystroke to keep set 50 selected. The exact keystroke performed is not intended to be a limiting part of the present invention. For example, the keystroke could be control-s. Once the keystroke has been performed, the user can then select set 52 while set 50 remains selected. In previous systems, an attempt to select set 52 would result in de-selection of set 50. It should be understood that more than two sets could be selected under the present invention. Specifically, after selecting set 52, the user could perform the keystroke again and then select another set (not shown). This could be repeated up to N sets (where N is more than one) as the buffer of the particular system would allow.

As further shown in FIG. 2, sets 50 and 52 are non-contiguous. That is, sets 50 and 52 are separated by other data 54. This may often be the case as the user may wish to copy only sporadic portions of the existing work. However, it should be understood that selected sets could be contiguous. For example, the user may wish to separately select the first five lines and the last five lines of set 50. To do this, the user would employ the same methodology described above. Specifically, the user would select the first five lines, perform the keystroke, and then select the last five lines.

If the user wishes to de-select one or more selected sets of data, the user can do so using undo system 39 shown in FIG. 1. In one embodiment, undo system 39 can cause de-selection of the last selected set (e.g., set 52). In another embodiment, the undo system 39 can cause de-selection of all sets (e.g., sets 50 and 52). In yet another embodiment, the user could click a mouse button on a specific set to be de-selected and then use undo system 39 to cause its de-selection. Similarly, undo system 39 could also allow the user to de-select one or more selection portions. To cause such de-selection, the user could use undo system 39 in conjunction with a keystroke (e.g., clicking the right mouse button on a portion desired to be de-selected, pressing control-d, etc.) to cause de-selection of one or more portions. Accordingly, undo system 39 provides the user with the efficient capability to de-select erroneously selected sets and/or portions.

The present invention also allows for second level selection. This is enabled by portion selection system 30 of FIG. 1 and is where a portion (e.g., a word) of a selected set is itself selected. For example, if the user wished to manipulate (e.g., edit, delete, etc.) the portion/term “object” in set 50, he/she could do so in a manner similar to the selection of sets 50 and 52. Specifically, once set 50 has been selected, the user could select the first occurrence of the portion 56A in set 50 using the right mouse button (as opposed to the left mouse button used to select sets 50 and 52). Then the user would perform a second keystroke (e.g., control-p) to allow portion 56A to remain selected during selection of portion 56B. Once portion 56B has been selected, the keystroke would be performed again so that portion 56C could be selected without de-selecting portions 56A-B. Then, the keystroke would be performed again to allow for selection of portion 56D without de-selection of portions 56A-C. The same methodology could then be used to select portions 58A-C of set 52.

It should be understood that the present invention could be extended beyond second level selection. For example, the user could select the entire first line of set 50 as a first portion, perform a keystroke, and then select the term “object” as a second portion. In this case, the selection of the term “object” would be ternary level selection. Accordingly, it should be appreciated that the present invention could be extended to N level selection (where N is more than one).

Once sets 50 and 52 and portions 56A-D and 58A-C have been selected, the user could then copy/cut, and paste the selected sets to a new area (e.g., the new work). Cutting, copying, and/or pasting are achieved via cut system 34, copy system 36, and paste system 38 shown in FIG. 1. Cut system 34, copy system 36, and paste system 38 are similar to those currently implemented in applications such as MS Word, MS Excel, etc. As well known in the art, cutting and copying of data occurs from the present area to a clipboard. The pasting operation copies the data from the clipboard to the new area. Under the present invention all selected sets are cut/copied and pasted as one unit (i.e., simultaneously). Previous system required that each desired set be cut/copied and pasted as individual units.

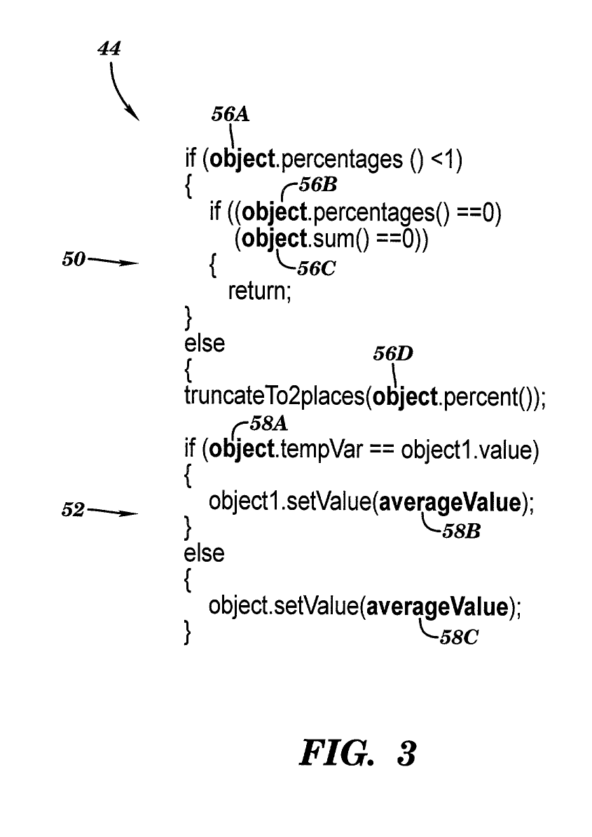

FIG. 3 depicts an exemplary new work 44. As shown sets 50 and 52 have been copied from existing work 40. In one embodiment, sets 50 and 52 can be pasted in the order they were selected. However, it should be understood that other variations exist. For example, sets could be pasted in the order they appeared in the existing work. Thus, if a user started selecting sets from the bottom of a work, the bottom selected set would remain at the bottom of the new work.

Although sets 50 and 52 are no longer selected in FIG. 3, the selected portions 56A-D and 58A-C remain selected. This allows/reminds the user to manipulate the selected portions. Manipulation occurs via manipulation system 32 of FIG. 1 and can involve editing, replacing, or deleting the selected portions. In a first embodiment, manipulation occurs when the user performs another keystroke such as pointing the mouse to a selected portion, and clicking the right mouse button. This keystroke could cause a menu of manipulation options to appear for the user. Such options could include “delete,” “replace with,” “replace in all places with,” “prompt for each instance,” etc. The “replace in all instances” option would allow the user to, for example, replace all occurrences of the portion “object” using a single command. Conversely, the “prompt for each instance” option would ask the user to confirm each potential replacement.

It should be appreciated that although FIG. 3 depicts a new work 44, the present invention can also be applied when adding to existing work 40 (i.e, modified existing work 46). For example, as described above, the user may desire to copy previous sets of data in a work he/she is currently preparing. This is often the case when writing computer programs because sections are often repeated. Thus, for example, if sets 50 and 52 of FIG. 2 were needed again in the same program, the user would utilize the present invention to efficiently copy the sets to the areas where they are needed.

Referring back to FIG. 1, communication with computer system 10 occurs via communication links 42. Communications links 42 can include a direct terminal connected to the computer system 10, or a remote workstation in a client-server environment. In the case of the latter, the client and server may be connected via the Internet, wide area networks (WAN), local area networks (LAN) or other private networks. The server and client may utilize conventional token ring connectivity, Ethernet, or other conventional communications standards. Where the client is connected to the system server via the Internet, connectivity could be provided by conventional TCP/IP sockets-based protocol. In this instance, the client would utilize an Internet service provider outside the system to establish connectivity to the system server within the system.

It is understood that the present invention can be realized in hardware, software, or a combination of hardware and software. Moreover, computer system 10 according to the present invention can be realized in a centralized fashion in a single computerized workstation, or in a distributed fashion where different elements are spread across several interconnected systems (e.g., a network). Any kind of computer/server system(s)—or other apparatus adapted for carrying out the methods described herein—is suited. A typical combination of hardware and software could be a general purpose computer system with a computer program that, when loaded and executed, controls computer system 10 such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for selecting multiple sets of data in an application, comprising the steps of:
selecting a first set of data within the application; and
selecting a second set of data within the application, wherein the first set of data remains selected during the selection of the second set of data.

2. The method of claim 1, further comprising the step of performing a predetermined keystroke after the first selecting step, wherein the selected keystroke allows the first set of data to remain selected during the selection of the second set of data.

3. The method of claim 1, further comprising the steps of:
simultaneously copying the selected sets of data; and
simultaneously pasting the copied sets of data to a predetermined area.

4. The method of claim 1, further comprising the step of selecting a first portion of one of the selected sets of data.

5. The method of claim 4, further comprising the steps of:
selecting a second portion of the selected set of data, wherein the first portion remains selected during the selection of the second portion based upon a predetermined keystroke; and
manipulating the selected portions.

6. The method of claim 1, wherein the first set of data and the second set of data are non-contiguous.

7. The method of claim 1, wherein the data is text.

8. The method of claim 1, further comprising the step of de-selecting a selected set of data.

9. A method for selecting multiple sets of data in an application, comprising the steps of:
providing an application for manipulating data;
selecting a first set of data within the application;
performing a first predetermined keystroke; and
selecting a second set of data within the application, wherein the first set of data remains selected during the selection of the second set of data.

10. The method of claim 9, further comprising the steps of:
selecting a first portion of one of the selected sets of data;
performing a second predetermined keystroke; and
selecting a second portion of the selected set of data, wherein the first portion remains selected during the selection of the second portion based upon the second predetermined keystroke.

11. The method of claim 10, further comprising the step of pasting the selected sets of data to a predetermined area.

12. The method of claim 11, further comprising the step of manipulating the selection portions in the predetermined area.

13. The method of claim 9, wherein the first set of data and the second set of data are non-contiguous.

14. The method of claim 9, wherein the data is text.

15. The method of claim 9, wherein the application is for writing computer code.

16. The method of claim 9, further comprising the step of de-selecting a selected set of data.

17. A method for selecting multiple sets of data in an application, comprising the steps of:
providing an application for writing computer code;
selecting a first set of data within the application;
performing a predetermined keystroke;
selecting a second set of data within the application after selecting the keystroke, wherein the first set of data remains selected during the selection of the second set of data based upon the keystroke;
selecting a portion of one of the selected sets of data;
pasting the selected sets of data to a predetermined area; and
manipulating the selected portion after the pasting step.

18. The method of claim 17, further comprising the step of copying the selected sets of data, prior to the pasting step.

19. The method of claim 17, further comprising the step of cutting the selected sets of data, prior to the pasting step.

20. The method of claim 17, wherein the data is text.

21. A program product stored on a recordable medium for selecting multiple sets of data in an application, which when executed, comprises:
program code configured to select a first set of data and a second set of data within the application, wherein the first set of data remains selected during the selection of the second set of data based upon a predetermined keystroke; and
program code configured to select a portion of one of the selected sets of data.

22. The program product of claim 21, wherein the application is an application for writing computer code and comprises:
program code configured to copy the selected sets of data;
program code configured to cut the selected sets of data;
program code configured to paste the selected sets of data;
program code configured to de-select a selected set of data; and
program code configured to manipulate the selected portion.

23. A system for selecting multiple sets of data in an application, comprising:
a set selection system for selecting a first set of data and a second set of data within the application, wherein the first set of data remains selected during the selection of the second set of data based upon a predetermined keystroke; and
a portion selection system for selecting a portion of one of the selected sets of data.

24. The system of claim 23, further comprising a manipulation system for manipulating the selected portion.

25. The system of claim 23, further comprising:
a copy system for copying the selected sets of data;
a cutting system for cutting the selected sets of data;
a pasting system for pasting the selected sets of data; and
an undo system for de-selecting a selected set of data.

26. The system of claim 25, wherein the undo system allows a user to de-select a selected portion.
